(19) United States
(12) Patent Application Publication
(10) Pub. No.: US 2011/0013381 A1
(43) Pub. Date: Jan. 20, 2011

(54) LIGHTING MODULE, IN PARTICULAR FOR BACK-LIGHTING

(76) Inventor: Guillaume Boulais, Levallois Perret (FR)

Correspondence Address: YOUNG & THOMPSON, 209 Madison Street, Suite 500, Alexandria, VA, 22314, US

(21) Appl. No.: 12/933,119

(22) PCT Filed: Mar. 20, 2009
(86) PCT No.: PCT/FR09/50476

§ 371 Date: Sep. 17, 2010

(30) Foreign Application Priority Data
Mar. 20, 2008 (FR) 0851808

(51) Int. Cl. G02F 1/13357; B29C 41/20

(52) U.S. Cl. 362/97.1; 264/261

(57) ABSTRACT

A lighting module (1) includes:
a plurality of light emission sources (2),
a light guide plate (3) having a transmission face (4) arranged to transmit light emitted by the emission sources (2) outside the guide towards an object to be lit and a return face (5) opposite the transmission face (4), and
elements (12, 13) for returning towards the inside of the guide (3), light emitted by the emission sources (2) and received by the return face (5). The emission sources (2) are situated on the inside of the light guide (3) between the transmission face (4) and the return face (5), each of the emission sources (2) being arranged to emit light in a direction of emission (9, 29) substantially parallel to the return face (5).

### TECHNICAL FIELD

The present invention relates to a lighting module. In particular, it relates to a back-lighting module.

Such a module can make it possible to create an ambient lighting for example in a room or in the form of a dome light of a motor vehicle. A field of application of the invention can for example be more particularly that of lighting the contents of shelving or furniture, or for lighting a room in place of a group of neon tubes.

Such a module can also allow back-lighting of various objects, for example a small label on a supermarket shelf or a large advertising poster in a street. A field of application of the invention can for example be more particularly that of back-lighting commercial signs, advertising posters or street signs, or also that of backlighting LCD screens, in particular large-dimension LCD screens.

### STATE OF THE ART

Documents U.S. Pat. No. 7,226,182 and US 2007/0274103 are known, which describe back-lighting modules, comprising typically:
a light guide plate, comprising two opposing flat faces connected by lateral edges.
a light emission source arranged on the side of one of the lateral edges of the panel and arranged so as to emit light towards the panel,
means placed on the side of one of the flat faces of the panel and arranged to reflect light originating from the emission source towards the other flat face, the object to be back-lit being located beside this other flat face,

The larger the size of the object to be back-lit, the larger the size of the module, and the more powerful the emission source must be. The module is then costly to manufacture and to supply with electrical power. Typically, use of this type of module is favoured for objects of small size, for example for the back-lighting of a screen of a mobile phone.

The purpose of the present invention is to propose an economical lighting module (in terms of manufacture, consumption and/or maintenance) and capable of being adapted to objects of large size.

### DISCLOSURE OF THE INVENTION

This objective is achieved with a lighting module comprising:
a plurality of light emission sources,
a light guide comprising a transmission face arranged to transmit light emitted by the emission sources towards an object to be lit and a return face opposite the transmission face, and
means for returning towards the inside of the light guide, light emitted by the emission sources and received by the return face,
   characterized in that the emission sources are situated on the inside of the light guide between the transmission face and the return face, and are arranged to emit light in a direction of emission substantially parallel to the return face.

In this document, by direction of light emission is meant the direction taken by the central axis of a solid angle in which this light is emitted.

Thus, according to a feature of the invention, the emission sources preferably do not light directly in the direction of the transmission face, but rather parallel to the return and/or transmission face, so as to better distribute the light in the light guide panel.

By distributing a plurality of emission sources in the light guide panel, the size of the panel can be very large despite the fact that each emission source can be low-power, of standard manufacture and inexpensive.

Preferably, the emission sources are inserted in the light guide beside the return face.

In order to insert the emission sources inside the guide, the guide is preferably constituted by a material which is initially liquid or pasty during the manufacture of the module, said material being solidified (by cooling, thermofusion, polymerisation, cross-linkage or other) after insertion of the emission sources into the guide. The emission sources carried by printed circuits can for example be coated with the liquid or pasty material. The pasty material can for example consist of:
Ethylene Vinyl Acetate (EVA) heated and cross-linked at 145° C. and pressed under vacuum against the face of the printed circuits which carry the emission sources, or
another more transparent material requiring a lower temperature such as silicon wafers heated to 110° C. this time without cross-linking,
other materials can also be envisaged such as a UV resin for example.

Thus, the emission sources are preferably situated in the guide without intermediate space between the guide and the emission sources, in particular without an air space.

The light guide can typically comprise moreover at least one peripheral surface connecting the transmission face to the return face, the emission sources being surrounded by the at least one peripheral surface.

The emission sources are preferably light emitting diodes of the “side view” type.

The emission sources are preferably grouped according to at least one row of emission sources, each row comprising emission sources approximately aligned according to one direction of alignment, and arranged to emit light according to a principal direction of emission approximately perpendicular to the direction of alignment.

The plurality of emission sources can be carried by at least one printed circuit pressed or glued against the return face. Thus, each printed circuit is preferably situated on the side of the return face with respect to the light guide, is substantially parallel to the return face, and is preferably pressed against the return face. The at least one printed circuit can comprise electrical resistances electrically connected to the emission sources, and said resistances can be buried in the at least one printed circuit in order not to protrude from the surface of the at least one printed circuit oriented towards the guide.

The emission sources of a row can be carried by several printed circuits electrically connected to each-other in order to supply these emission sources or can be carried by a single printed circuit. At least one printed circuit from a given row can comprise at least one additional emission source substantially aligned with the emission sources of this given row, each additional source being arranged to emit light in a direction corresponding to the main direction deflected towards a neighbouring printed circuit.

The module according to the invention can comprise several parallel rows of emission sources, electrically connected together in order to supply the emission sources. At least one printed circuit can carry:
a first line of emission sources arranged to emit light in a first main direction of emission, and
a second line of emission sources parallel with the first line and of which the emission sources are arranged in order to emit light in a second main direction of emission, the first direction of emission being approximately opposite to the second direction of emission.

Preferentially, the first line and the second line are opposite each other.

The return means can comprise a reflecting layer arranged to reflect towards the inside of the guide the light emitted by the emission sources and received by the return face. The reflecting layer can be situated directly in contact with all or part of the return face, and in particular can be situated between the at least one printed circuit and the return face.

In this document, a distinction will be made between the emission sources which create light (for example from an electrical signal) and the diffusion sources which diffuse or back-scatter the already existing light that they have collected.

Thus, the reflecting means can comprise light diffusion sources situated on the side of the return face with respect to the light guide, and arranged to collect the light emitted by the emission sources and received by the return face then to re-diffuse the collected light towards the guide. The diffusion sources situated on the side of the return face preferably comprise recessed and/or protruding structures distributed on the return face. The return face can be frosted.

The module according to the invention can moreover comprise light diffusion sources situated on the side of the transmission face with respect to the light guide, and arranged to collect the light emitted by the emission sources and received by the transmission face to then re-diffuse the received light towards the object to be lit. The diffusion sources situated on the side of the transmission face preferably comprise recessed and/or protruding structures distributed on the transmission face. The transmission face can be frosted.

Thus by combining a light emission in a direction parallel to the return and/or transmission face with diffusion sources produced on the return and/or transmission or diffusion face, a very homogeneous light is obtained at the output of the guide.

Thus, the diffusion sources which can be produced on the return and/or transmission face preferably comprise recessed and/or protruding structures distributed respectively on the return and/or transmission face. These structures are preferably microstructures. These structures make it possible preferably to refract the light, so as to have sufficient light directed towards the transmission face. The density of the structures can be different in order to distribute the light uniformly towards the transmission face: when the angle of incidence on the return face is greater than a critical angle (dependent on the refractive index of the materials used and therefore of the media and materials) the reflection is total (no more transmission loss) and this is what is sought preferably in the light guide in order to reduce losses. The light which exits from the guide on the side of the return face is preferably recovered using a reflector (for example white or metallic, etc.) but this time the energy loss is more significant. Various technologies are known such as the V-cut, lenses, etching (chemical treatment) or prisms technologies to produce these structures, and it is possible optionally to mix the different forms and these structures can be placed on the return face side and/or on the transmission face side. The structures can have small sizes of the order of one micron or a few tens of microns for example.

The module according to the invention can moreover comprise, on the side of the transmission face with respect to the light guide, a transmission film of which the light transmission coefficient is inhomogeneous so as to compensate an inhomogeneity of light emerging from the transmission face due to an inhomogeneity of distribution of the emission sources in the light guide. The transmission film can be a layer printed for example by ink jet, screen printing, flexography, or other, in particular printed on a layer acting as a diffuser. Preferentially, for at least one of the emission sources, the transmission coefficient of the transmission film increases when there is a greater distance from this emission source in the direction of emission of this emission source. The transmission film can moreover be arranged to compensate for an inhomogeneity of light emerging from the transmission face due to a curvature of the light guide. The transmission film can for example comprise local minima of the transmission coefficient of the light at the level of at least one intersection between two directions of emission of at least two emission sources.

The module according to the invention is preferably flexible so that it can be rolled up on itself in the form of a roll, or can be pressed against an object to be back-lit while adopting as far as possible the shape of this object, i.e. with the least possible space between the module and this object.

In this document, it is said that the module according to the invention or one of its components is flexible if its form is capable of adapting itself, for example if it can adopt many shapes according to the shape of the object against which it is pressed.

The module according to the invention can moreover comprise means of periodic access to the means which electrically connect the emission sources for the supply of electricity to the emission sources. In particular, if the module comprises several printed circuit strips carrying the emission sources and regularly spaced, each of these strips can be provided with means of electrical connection accessible from the outside of the module according to the invention.

The emission sources are preferably situated in the guide without an intermediate space between the guide and the emission sources, in particular without an air space.

The guide can comprise an initially liquid or pasty material which is solidified after insertion of the emission sources into the guide.

The emission sources are preferably carried by at least one printed circuit.

The guide comprises preferably lateral edges connecting the transmission face and the return face, at least one row of emission sources being preferably situated inside the light guide between the transmission face and the return face outside the lateral edges of the guide.

The module according to the invention can comprise moreover on the side of the return face or the transmission face of the guide:
a layer of air which is in contact respectively with the return face or the transmission face of the guide, or
a layer which has a refractive index less than a refractive index of the guide and which is in contact respectively with the return face or the transmission face of the guide.

In this document, by refractive index less than that of the guide is meant a refractive index preferably less by a value of at least 0.1 or 0.2.

The module according to the invention can comprise a strip along which an elongated recess is formed, the strip carrying at least one line of emission sources situated inside the elongated recess and aligned along the elongated recess, the recess being filled with material forming part of the light guide. Of course, in this document, when one says that a module comprises one strip, it is meant that the module comprises at least one strip. Likewise, in this document, when one says that a recess is formed along a strip, it is meant that at least one recess is formed along this strip, a strip can comprise a plurality of elongated recesses that are parallel or not. The strip can carry two lines of emission sources inside the elongated recess, each line being arranged to emit light in a different direction. Each source carried inside the elongated recess is preferably arranged to emit light in a direction of emission substantially parallel to a portion of the recess of the strip carrying this source. The strip is preferably situated on the side of the return face of the guide. The strip can comprise means for returning towards the interior of the light guide, the light emitted by the emission sources and received by the return surface. The strip can carry inside the recess, at each end of the strip, emission sources which light in the direction of the outside of the recess, substantially perpendicularly to the direction of emission of the at least one line of sources carried by this strip.

The module according to the invention can comprise, on the light guide on the transmission face side, a mask situated above the emission sources to mask the light close to these emission sources, the mask comprising preferably:
optionally a UV gel printing situated on the transmission face and having preferably an index less than that of the guide, then
a dark colour printing situated over the low index UV gel, or over the transmission face if no UV gel printing is present, then
a coating over the colour printing, with beads and/or diffuser resin and/or a diffuser pattern (hemispheres).

According to another aspect of the invention, a process for manufacturing a lighting module is proposed characterized in that:
emission sources are inserted in a light guide comprising a material which is initially liquid or pasty, the light guide comprising a transmission face arranged for transmitting light emitted by the emission sources towards an object to be lit and a return face opposite the transmission face, the emission sources being inserted so that they are situated inside the light guide between the transmission face and the return face
the material of the guide is solidified after insertion of the sources in the guide.

The insertion can comprise a coating of the emission sources with the liquid or pasty material.

The sources are preferably inserted so that the sources are situated in the guide without intermediate space between the guide and the emission sources, in particular without an air space.

Preferably, the emission sources are inserted between the transmission face and the return face so that the sources are arranged to emit light in a direction of emission substantially parallel to the return face.

During the insertion of the sources into the guide, the sources are preferably carried by at least one printed circuit.

The guide can comprise lateral edges connecting the transmission face and the return face, and at least one row of sources can be inserted outside the lateral edges of the guide.

In the process according to the invention, a mask can be produced directly on the light guide, on the transmission face side and above emission sources, to mask the light close to these emission sources, preferably by producing:
optionally a first UV gel printing on the transmission face and having preferably an index less than that of the guide, then
a dark colour printing over the low index UV gel, or over the transmission face if no UV gel printing is present, then
a coating over the colour printing, with beads and/or diffuser resin and/or a diffuser pattern (hemispheres).

In a first variant, the insertion can comprise a moulding of at least one part of the guide on a substrate on which the emission sources are arranged. This substrate can act as a support to the guide which is liquid or pasty during manufacture in order to integrate the sources, and it can also act as a support to the sources. For example in a first mode of manufacture, the sources are arranged on the substrate, then an acrylic or epoxy resin is deposited on the assembly by casting. In a second mode of manufacture, the sources are arranged on the substrate, then the sources and the substrate are covered with a solid silicone film which becomes liquid for manufacturing the guide by making it melt under pressure or under vacuum. Finally in a third mode of manufacture, it is possible to extrude the pasty guide that has just been deposited, still in the pasty state, on the substrate equipped with the emission sources (“Cast Film”).

A moulding face of the guide from the transmission or return faces can be in contact with the substrate during the moulding, the substrate comprising recessed and/or protruding structures distributed on its surface which is in contact with the moulded part of the guide during the moulding so that the guide comprises respectively protrusions and/or recesses distributed on the moulding face.

The moulded part of the guide can be completed by adding on the side of the return face or the transmission face of the guide:
a layer of air which is in contact respectively with the return face or the transmission face of the guide, or
a layer which has a refractive index less than a refractive index of the guide and which is in contact respectively with the return face or the transmission face of the guide.
and/or a layer which has a refractive index approximately equal to a refractive index of the moulded part of the guide, which completes the moulded part of the guide, which forms part of the guide and which comprises a distribution of recessed and/or protruding structures.

It is possible for the substrate not to form part of the module, and the moulded part of the guide is removed from the substrate.

Otherwise, the substrate can form part of the module, the moulded part of the guide not being removed from the substrate. The substrate can comprise:
means for returning towards the inside of the guide, light emitted by the emission sources and received by the return face or means for diffusing towards the outside of the guide, light emitted by the emission sources and received by the transmission face, and/or
a layer which is in contact with the transmission or return face of the guide and which has a refractive index less than a refractive index of the guide. This layer in contact with the guide and having a lower index comprises advantageously structures (preferably microstructures) which are recessed and/or protruding, distributed on its surface which is in contact with the moulded part of the guide during the moulding, so that the guide comprises respectively protrusions and/or recesses distributed on the moulding face. This layer can be produced by deposition of UV gel (or any other resin) on which a mechanical pressure is applied, for example by means of a roller for forming the structures on the surface of this layer or by means of a plate exerting pressure on the gel, the roller or the plate containing the complementary protruding and/or recessed shapes. Numerous UV gels can be used for this layer, in general ACRYLATE or METHACRYLATE-BASED such as EPOXY ACRYLATE, EPOXY METHACRYLATE, URETHANE ACRYLATE, URETHANE METHACRYLATE, ACRYLATE, having in general an index close to 1.5 or higher up to 1.6 or 1.7 with special formulations. In order to reduce the refractive index of this layer, additional molecules can be included like fluorinated compounds and it is possible to have indices around 1.3. Other means of cross-linking exist depending on the materials used (heat, gamma rays, mixture, etc.). The resins solidify due to the assembly of chemical bonds and the process is not reversible, in contrast to thermoplastics which can be re-melted such as certain silicones; and/or
a layer which is in contact with the moulded part of the guide, which has a refractive index preferably approximately equal to a refractive index of the moulded part of the guide, which completes the moulded part of the guide and which forms part of the guide. This layer having a preferably equal index can comprise recessed and/or protruding structures distributed on a first surface opposite a second surface which is in contact with the moulded part of the guide. These structures can be produced directly by moulding, hot compression of the material, they can also be produced by coating a UV gel on a film or a smooth plate. The first face of the preferably equal index layer can be placed in contact with a layer of air or with a layer which has a refractive index less than a refractive index of the guide.

In a second variant, the insertion of the sources in the guide can comprise the following steps:
providing a strip along which an elongated recess is formed, the strip carrying at least one line of emission sources situated inside the elongated recess and aligned along the elongated recess,
application of the recessed side of the strip onto a first part of the light guide,
filling the recess with the liquid or pasty material in order to form a second part of the light guide in contact with the first part of the light guide.

The strip can be part of a plate comprising this strip, and the recess of the strip can be formed by bending the plate.

Before filling, the first part of the light guide can be solid, the second part of the light guide being solidified after filling.

The strip can comprise a filling hole through which the recess is filled with the liquid or pasty material. Advantageously, the hole is preferably placed on the side of the strip or towards one of its ends on a stopper.

The strip can carry two lines of emission sources inside the elongated recess, each line being arranged to emit light in a different direction.

Each source carried inside the elongated recess can be arranged to emit light in a direction of emission substantially parallel to a portion of the recess of the strip carrying this source.

The strip can be applied on the side of the return face of the guide, and can comprise means for returning towards the interior of the light guide, light emitted by the emission sources and received by the return surface.

At each end of the strip, the strip can carry inside the recess, emission sources which light in the direction of the outside of the recess, substantially perpendicularly to the direction of emission of the at least one line of sources carried by this strip.

According to another aspect of the invention, the invention relates to a lighting module obtained by the manufacturing process according to the invention.

According to another aspect of the invention, a strip is proposed for the manufacture of a lighting module according to the invention, characterized in that an elongated recess is formed along this strip, the strip carrying at least one line of emission sources inside the elongated recess and aligned along the elongated recess.

The strip according to the invention can comprise a filling hole for filling the recess with liquid or pasty material when the strip is applied to a first part of a light guide on the recessed side of the strip. Advantageously, the hole is preferably placed on the side of the strip or towards one of its ends on a stopper.

The strip according to the invention can carry two lines of emission sources inside the elongated recess, each line being arranged to emit light in a different direction.

Each source carried inside the elongated recess is preferably arranged to emit light in a direction of emission substantially parallel to the portion of the recess of the strip carrying this source.

The strip according to the invention can comprise means for reflecting light emitted by the emission sources.

At each end of the strip, the strip can carry inside the recess, emission sources which light in the direction of the outside of the recess, substantially perpendicularly to the direction of emission of the at least one line of sources carried by this strip.

### DESCRIPTION OF FIGURES AND EMBODIMENTS

Other advantages and features of the invention will become apparent on reading the detailed description of implementations and embodiments which are in no way limitative, and from the following attached drawings:

FIG. 1 is a diagrammatic top view of a first embodiment of the module according to the invention,

FIG. 2 is a diagrammatic top view of a second embodiment of the module according to the invention,

FIG. 3 is a diagrammatic top view of a third embodiment of the module according to the invention

FIG. 4 is a diagrammatic sectional side view along the axis 26 of FIG. 3, of the third embodiment of the module according to the invention, laid flat,

FIG. 5 is a diagrammatic top view of a fourth embodiment of the module according to the invention, which is a preferred embodiment of the invention,

FIG. 6 is a diagrammatic sectional side view, along the axis 27 of FIG. 5, of a variant of the fourth embodiment of the module according to the invention, laid flat,

FIG. 7 is a diagrammatic sectional side view, along the axis 27 of FIG. 5, of the fourth embodiment of the module according to the invention in a curved position,

FIG. 8 is a diagrammatic top view of a fifth embodiment of the module according to the invention,

FIG. 9 is a diagrammatic sectional side view along the axis 28 of FIG. 8, of the fifth embodiment of the module according to the invention, laid flat,

FIG. 10 is a diagrammatic sectional profile view of a sixth embodiment of the module according to the invention,

FIG. 11 is a diagrammatic sectional profile view of a seventh embodiment of the module according to the invention,

FIG. 12 is a diagrammatic sectional profile view of an eighth embodiment of the module according to the invention,

FIG. 13 is a diagrammatic sectional profile view of a ninth embodiment of the module according to the invention,

FIG. 14 is a diagrammatic sectional profile view of a tenth embodiment of the module according to the invention,

FIG. 15 is a diagrammatic sectional profile view of an eleventh embodiment of the module according to the invention,

FIG. 16 is a diagrammatic sectional profile view of a twelfth embodiment of the module according to the invention,

FIG. 17 is a diagrammatic sectional profile view of a thirteenth embodiment of the module according to the invention,

FIG. 18 is a diagrammatic perspective view of the thirteenth embodiment of the module according to the invention,

FIG. 19 is a diagrammatic sectional profile view of a fourteenth embodiment of the module according to the invention,

FIG. 20 is a diagrammatic perspective view of the fourteenth embodiment of the module according to the invention,

FIG. 21 is a diagrammatic sectional profile view of a fifteenth embodiment of the module according to the invention,

FIG. 22 is a diagrammatic sectional profile view of a sixteenth embodiment of the module according to the invention,

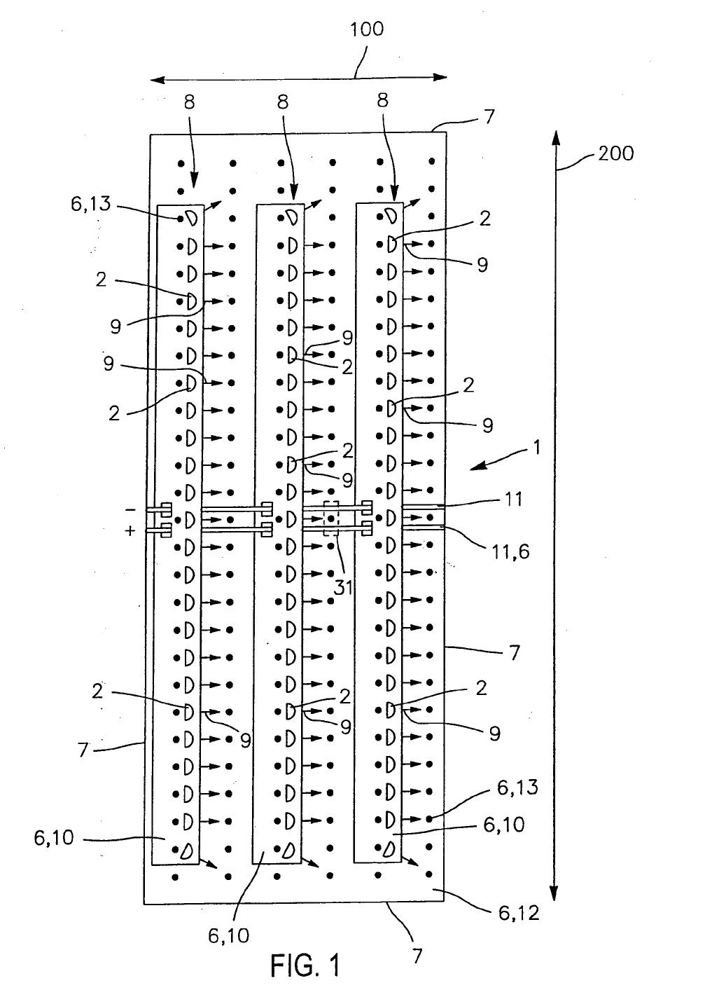

Firstly, with reference to FIGS. 1 to 7 and 10 to 22, features will be described which are common to the first 4 embodiments of a lighting module 1 according to the invention and the sixth to sixteenth embodiment of a lighting module 1 according to the invention.

Module 1 comprises:
a plurality of light emission sources 2 (and optionally 19), and
a light guide plate 3, produced from a transparent material, i.e.

which substantially does not absorb the light emitted by the emission sources 2, 19 in order to guide this light outside the guide 3.

The guide 3 has substantially the form of a plate comprising two opposed faces lining the guide: a substantially flat transmission face 4 and a substantially flat return face 5. This plate is flexible, and can be laid flat or adopt curve shapes. These two faces have substantially similar dimensions, and define the length 100 and the width 200 of the guide 3 and thus of the module 1. The transmission face 4 is arranged to allow light emitted by the emission sources 2, 19 inside the guide 3 to pass through and be transmitted outside the guide 3 towards an object to be lit. The object to be lit is situated outside the guide 3, on the side of the transmission face 4 with respect to the guide 3. This object is preferably back-lit, i.e. it is situated between the observer and the guide 3. The return face 5 is opposite to the transmission face 4. The return face 5 is substantially parallel to the transmission face 4, except at the level of strips 38 comprised in certain embodiments described below. In the sectional FIGS. 4, 6 and 7, 10 to 17, 19, 21 and 22 the transmission face 4 corresponds to the continuous line lining the upper side of the guide 3, and the return face 5 corresponds to the continuous line lining the lower side of the guide 3.

Each of the emission sources 2, 19 is arranged to emit light in a direction of emission 9 (or optionally 20, 21, or 29) substantially parallel to the return face 5.

Module 1 comprises moreover return means 6, arranged in order to return towards the inside of the light guide 3, light emitted by the emission sources 2, 19 inside the guide 3 and received by the return face 5.

FIGS. 1, 2, 3, and 5 illustrate the module 1 laid flat and viewed from above along a plane substantially parallel to the transmission 4 and return faces 5, to the guide 3 and to the other films and layers superimposed on the guide 3; it is therefore not possible to distinguish between these different elements on these figures.

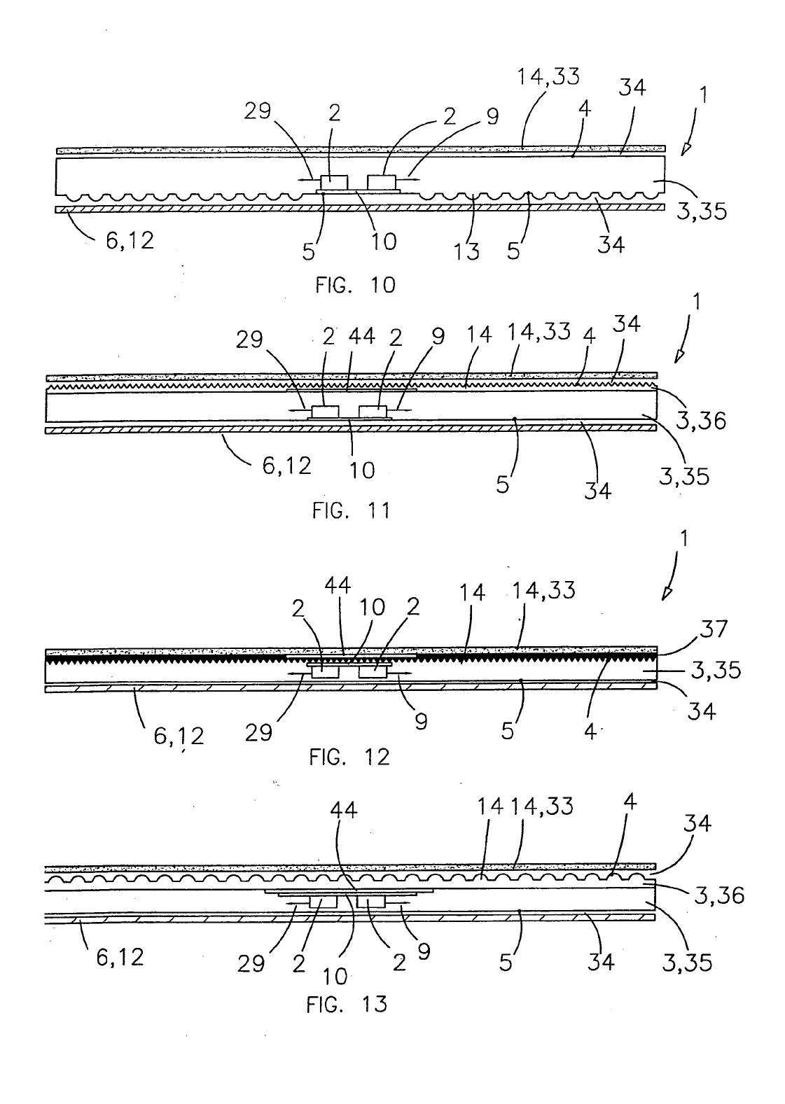

Each of the emission sources 2, 19 is shown diagrammatically in FIGS. 1 to 7 with a D shape and on the FIGS. 10 to 22 with a square shape. In order to avoid overcrowding the figures, not all the emission sources are referenced. The emission sources 2, 19 are situated inside of the guide 3: these emission sources 2, 19 are inserted inside the guide 3 from the return face 5, with the exception of the eighth and ninth embodiments described with reference to FIGS. 12 and 13 and for which these emission sources 2, 19 are inserted inside the guide 3 from the transmission face. The guide 3 comprises moreover a peripheral surface 7 (also called lateral edges) connecting the transmission face 4 to the return face 5, so that the emission sources 2, 19 are surrounded by the peripheral surface 7. The distance connecting the faces 4 and 5 along the peripheral surface 7 is the thickness of the guide 3. A thickness of one of the components of the module 1 is of generally defined perpendicularly to the return 5 or of transmission face 4.

Emission sources 2 form several parallel rows 8 of emission sources 2. At least one row 8 of emission sources is situated inside the light guide 3 between the transmission face 4 and the return face 5 outside the lateral edges 7 of the guide. FIGS. 10 to 22 represent only a portion of the module 1 in which a minimum of two of the rows of emission sources 2 are shown in profile, which is why the lateral edges 7 are not referenced in these figures.

Each row 8 comprises emission sources 2 substantially aligned according to a direction of alignment (corresponding to a vertical direction in the top views of FIGS. 1, 2, 3, 5) and arranged to emit light in a main direction of emission 9 (or optionally 29) diagrammatically shown by an arrow and substantially perpendicular to the direction of alignment. A width of one of the components of the module 1 is generally defined according to the direction of alignment of the emission sources 2. A length of one of the components of the module 1 is generally defined perpendicularly to its width and to its thickness.

The emission sources 2, 19 are distributed on a plurality of printed circuits 10. The faces of the printed circuits 10 carrying the emission sources are pressed against the return face 5 so that the printed circuit assembly 10 covers only a part of the return face 5, with the exception of the eighth embodiment described with reference to FIG. 12, for which the faces of the printed circuits 10 carrying the emission sources are pressed against the transmission face 4 so that the printed circuit assembly 10 covers only a part of the transmission face 4, and with the exception of the ninth and tenth embodiments described with reference to FIGS. 13 and 14 for which the faces of the printed circuits 10 carrying the emission sources are coated inside the guide between the transmission face 4 and the return face 5. All the rows 8 are electrically connected to each other by flat electrical wires 11 (typically comprising one wire for a positive terminal and another wire for a negative terminal) which are arranged in order to provide a supply of electricity to the emission sources, and are pressed against the return face 5. The part of the return face 5 not covered by the printed circuits 10 or the wires 11 is covered by a reflective layer 12 which reflects towards the inside the guide 3, light emitted by the emission sources and received by the return face 5 then by the layer 12, with the exception of the eighth and ninth embodiments described with reference to FIGS. 12 and 13 for which the emission sources are inserted inside the guide 3 from the transmission face and for which all of the return face 5 is covered by a reflective layer 12 which reflects towards the inside of the guide 3, light emitted by the emission sources and received by the return face 5 then by the layer 12.

Each of the emission sources is a light-emitting diode (LED) of the side view type, i.e. a emission source under consideration is arranged in order to emit light in a direction of emission 9 (or optionally 29) substantially parallel to the portion of the printed circuit 10 carrying said emission source. In the case of the embodiments described with reference to FIGS. 1 to 7, 10, 11 and 15 to 22, the printed circuits 10 are pressed against the return face 5, each of the emission sources is therefore arranged in order to emit light in a direction of emission substantially parallel to the portion of the return face 5 through which said emission source 2, 19 is inserted into the guide 3. Generally, for all the embodiments described, each of the emission sources is therefore arranged in order to emit light in a direction of emission substantially parallel to the portion of the return face 5 at the level of which this source is situated, i.e. in a direction of emission substantially parallel to the portion of the return face 5 closest to this source.

In addition to the reflective layer 12, the return means 6 comprise:
the surface of the printed circuits 10 oriented towards the return face 5, this surface being treated to reflect towards the inside of the guide 3, light emitted by the emission sources and received by the return face 5 then by the circuits 10,
the surface of the wires 11 oriented towards the return face 5, this surface being treated to reflect towards the inside of the guide 3, light emitted by the emission sources and received by the return face 5 then by the wires 11,
   with the exception of the eighth embodiment described with reference to FIG. 12 and for which the printed circuits 10 are pressed against the transmission face 4, and with the exception of the ninth and tenth embodiments described with reference to FIGS. 13 and 14 for which the printed circuits 10 are coated inside the guide between the transmission face 4 and the return face 5. As a surface treatment of the printed circuits 10 and/or the wires 11, reflective paint or ink can for example be distributed on this surface.

For the embodiments described with reference to FIGS. 1 to 7, 10, 14, 15, 16 and 22, the return means 6 include moreover sources of light diffusion 13, situated on the side of the return face 5 with respect to the guide 3, and arranged in order to collect the light emitted by the emission sources and received by the return face 5 then to re-diffuse the collected light towards the inside of the guide 3.

In FIGS. 1 to 7, the diffusion sources 13 are shown diagrammatically by black dots distributed on the return face 5. In order to avoid overcrowding FIGS. 1 to 7 and 10 to 22, not all the diffusion sources 13 are not referenced. Moreover, the actual density of the diffusion sources 13 is more significant than that shown on the figures, and these sources 13 are not necessarily distributed uniformly. In particular, the density and/or the dimensions of the diffusion sources 13 are preferably more significant, the more the distance from the emission sources increases. The diffusion sources 13 are arranged between, on the one hand, the guide 3 and, on the other hand ,the circuits 10, the wires 11 and the reflective layer 12.

The diffusion sources 13 can be produced directly on the return face 5, and can for example comprise:

1) a fine layer of material comprising particles diffusing the light and arranged on all of the return face 5, and/or a fine layer of material for example UV gel on which a microstructure is produced, and/or

2) spots of material distributed on the return face 5 and for example produced by screen printing, and/or

3) recesses or protrusions of material, for example recesses or protrusions of the material of which the guide 3 is composed as shown in FIGS. 10, 14, 15, 16 and 22, these recesses or protrusions being distributed on the return face 5 and being for example produced during a moulding or a lamination of the guide 3, and each recess or protrusion can have for example a shape of a prism, a pyramid, a V (“V-cut”), a lens or a portion of a sphere, and/or

4) a non uniform or frosted appearance of the return face 5, for example produced by sanding or by chemical treatment (“etching”) of the return face 5;

The diffusion sources 13 can also be produced directly on the surface, oriented towards the return face 5, the circuits 10 and/or the wires 11 and/or the reflective layer 12, and can for example consist of:

1) a fine layer of material comprising particles diffusing the light and arranged over all of this surface, and/or

2) spots of material distributed on this surface and for example produced by screen printing or by spraying, and/or

3) recesses or protrusions of material, for example recesses or protrusions of the material of which the circuits 10 and/or the wires 11 and/or the reflective layer 12 are composed, these recesses or protrusions being distributed on this surface and being for example produced during a moulding or a lamination respectively of the circuits 10 and/or the wires 11 and/or the layer 12, and each recess or protrusion can have for example a shape of a prism, a pyramid, a lens or a portion of a sphere.

The frosting of the return face 5 is a variant which minimizes the thickness of the module, and it therefore maximizes the flexibility of the module.

For the embodiments described with reference to FIGS. 1 to 7 and 10 to 22 the module 1 comprises moreover light diffusion sources 14, situated on the side of the transmission face 4 with respect to the guide 3, and arranged in order to collect the light emitted by the emission sources and received by the transmission face 4 then to re-diffuse the collected light towards the outside of the guide 3 and towards the upper layers 15, 16, 17.

In FIGS. 1 to 7, the diffusion sources 14 are shown diagrammatically by black spots distributed on the transmission face 4. In order to avoid overcrowding in FIGS. 1 to 7 and 10 to 22, not all the diffusion sources 14 are referenced. Moreover, the actual density of the diffusion sources 14 is more significant than that shown on the figures, and these sources 14 are not necessarily distributed uniformly. In particular, the density and/or the dimensions of the diffusion sources 14 are preferably more significant, the more the distance from the emission sources increases. The diffusion sources 14 are arranged between, on the one hand, the guide 3 and, on the other hand, the upper layers 15, 16, 17.

The diffusion sources 14 can be produced directly on the transmission face 4, and can for example consist of:

1) a fine layer of material comprising particles diffusing the light and arranged on all of the transmission face 4 (such as a PET film, for example from Eternal Chemical Co. Ltd n^{o}DI-780A/DI-780C having a typical thickness of 100-200 micrometres), and/or a fine layer of material for example UV gel on which a microstructure is produced, and/or

2) spots of material distributed on the transmission face 4 and for example produced by screen printing, and/or

3) recesses or protrusions of material, for example recesses or protrusions of the material of which the guide 3 is composed as shown in FIGS. 11 to 13 and 17 to 22, these recesses or protrusions being distributed on the transmission face 4 and being for example produced during a moulding or a lamination of the guide 3, and each recess or protrusion can have for example a shape of a prism, a pyramid, a V (“V-cut”), a lens or a portion of a sphere, and/or

4) a non uniform or frosted appearance of the transmission face 4, for example produced by sanding or by chemical treatment (“etching”) of the return face 4;

The diffusion sources 14 can also be produced directly on a surface of one of the upper layers 15 situated on the side of the transmission face with respect to the guide, in particular by means of a diffuser layer 33, and can for example consist of:

1) a fine layer of material comprising particles diffusing the light and arranged over all of this surface, and/or

2) spots of material distributed on this surface and for example produced by screen printing or by spraying, and/or

3) recesses or protrusions of material, for example recesses or protrusions of the material of which this upper layer 15 is composed, these recesses or protrusions being distributed on this surface and being for example produced during a moulding or an a lamination of this upper layer 15.

The frosting of the transmission face 4 is a variant which minimizes the thickness of the module, it reduces the number of layers and it therefore maximizes the flexibility of the module.

For all embodiments described with reference to FIGS. 1 to 7 and 10 to 22, the emission sources are situated in the guide without an intermediate space between the guide and the emission sources, in particular without an air space. The guide comprise an initially liquid or pasty material solidified after insertion of the emission sources into the guide. Thus, no cavities are produced in order to encapsulate the emission sources with an intermediate air space, which avoids the necessity to treat the surfaces of such cavities with an anti-reflective treatment in order to reduce energy losses by reflection.

For the embodiments described with reference to FIGS. 1 to 7, the upper layer situated on the side of the transmission face 4 with respect to the guide 3 and the closest to the guide is a transmission film 15 of which the light transmission coefficient is preferably inhomogeneous. The inhomogeneity of the transmission coefficient is arranged in order to compensate for an inhomogeneity in the distribution of the emission sources in the guide, so that the light originating from the guide 3, passing through the transmission face 4, then being directed towards the outside of the guide is as homogeneous as possible after having passed through the film 15. To this end, the transmission coefficient of the film 15 varies along the width and/or the length of the film 15. For each emission source, from the point 18 of the film 15 the closest to this emission source, the transmission coefficient of the film 15 increases in a continuous fashion as the distance from this emission source increases in the direction of emission 9 of this emission source. In other words, for each emission source, from the point 18 of the film 15 the closest to this emission source, the film 15 is more clear and transparent as the distance from this emission source increases in the direction of emission 9 of this emission source. Typically, the film 15 comprises an alternation of dark strips 22 (having a low transmission coefficient) superimposed on the rows 8 of LEDs and of clear strips 23 (having a high transmission coefficient) between the rows 8. A layer 16 comprising lenses is arranged on the transmission film 15. This layer 16 is optional. The layer 16 is arranged to receive light originating from the guide 3 and the film 15, so that after having passed through the layer 16, the light rays constituting this light are oriented substantially perpendicularly to the layer 16 and to the faces 4, 5. The upper layer 17 is arranged on the layers 15, 16 on the side of the transmission face 4 and consists of:
either the object to be back-lit by the module 1, so that an observer situated on the side of the transmission face with respect to the guide and downstream of the object observes this object,
or an adhesive film making it possible to bond the module 1 to the object to be back-lit by the module 1,
   the object to be back-lit being typically a layer comprising an image, for example an advertising image, a street sign or a commercial sign. This layer 17 is optional.

For the set of embodiments described with reference to FIGS. 1 to 7 and 10 to 22, the assembly of module 1 is flexible:
the reflective layer 12 is fine (a few tens or hundreds of micrometres in thickness) and is constituted of a flexible reflective material or consists of a fine layer of a metallic deposit or reflective white ink.
the printed circuits 10 and the wires 11 are also flexible; the circuits 10 typically comprise a polyimide film such as a Kapton® film from Du Pont of a few tens of micrometres in thickness (typically 0.1 mm); the printed circuits 10 moreover comprise electrical resistances (not shown in the figures) electrically connected to the emission sources and to the wires 11, typically one resistance per group of three LED-type emission sources. In order to avoid these resistances causing shadow zones by blocking the light emitted by the emission sources, these resistances are buried in the printed circuits 10, so that they do not protrude from the surface of the printed circuits and are therefore not situated inside the guide 3. Typically, there is one resistance per group of three LED-type emission sources, having a 12V direct current supply.
the guide 3 is constituted by a flexible material, preferably initially liquid or pasty during the manufacture of the module 1 then solidified (by cooling down, by thermofusion, by polymerisation or other) after insertion of the emission sources into the guide 3. The material of the guide is preferably an acrylate resin or a silicone film, but can optionally also be based on ethylene vinyl acetate (EVA). The thickness of the guide 3 is for example 0.8 millimetre (typically between 0.3 mm and 1.2 mm). The LEDs 2, 19 have a typical thickness of 0.5 millimetre, and can for example comprise “side view” LEDs model n^{o} NSSW045T or NSSW006T from Nichia Corporation.
the upper layers 15, 16 are also constituted by a flexible material, preferably capable of being solidified (by heat, by polymerization or other), such as an EVA-based material.

Finally, the set of embodiments described with reference to FIGS. 1 to 7 and 10 to 22 is produced according to the following manufacturing process:
emission sources are inserted into the light guide 3, the emission sources being inserted so that they are situated inside the light guide between the transmission face and the return face
the material of the guide is solidified after insertion of the sources into the guide.

The insertion comprises a coating of the emission sources with the liquid or pasty material. The sources are inserted so that the sources are situated in the guide without intermediate space between the guide and the emission sources, in particular without an air space. The emission sources are inserted between the transmission face 4 and the return face 5 so that the sources are arranged to emit light in a direction of emission substantially parallel to the return face 5. During the insertion of the sources into the guide, the sources are carried by at least one printed circuit 10. At least one row 8 of sources is inserted outside the lateral edges 7 of the guide.

Particular features of each of the first four embodiments of the module according to the invention will now be described.

Technically it is very difficult to manufacture a flexible printed circuit 10, the width or the length of which is greater than fifty centimetres and which can carry high currents.

In the first embodiment of the module according to the invention, with reference to FIG. 1, the assembly of the emission sources 2 of a given row 8 is carried by a single printed circuit 10 different from that of the other rows 8. Thus, by electrically connecting the circuits 10 of each of the rows 8 by the wires 11, the length 100 of the first embodiment of the module according to the invention is almost unlimited. Indeed, three rows 8 of emission sources are shown in FIG. 1, but the length of the first embodiment of the module according to the invention can comprise tens, hundreds or more rows 8.

However, it can be seen in FIG. 1 that the width 200 of the first embodiment of the module according to the invention is limited to the maximum width of each circuit 10.

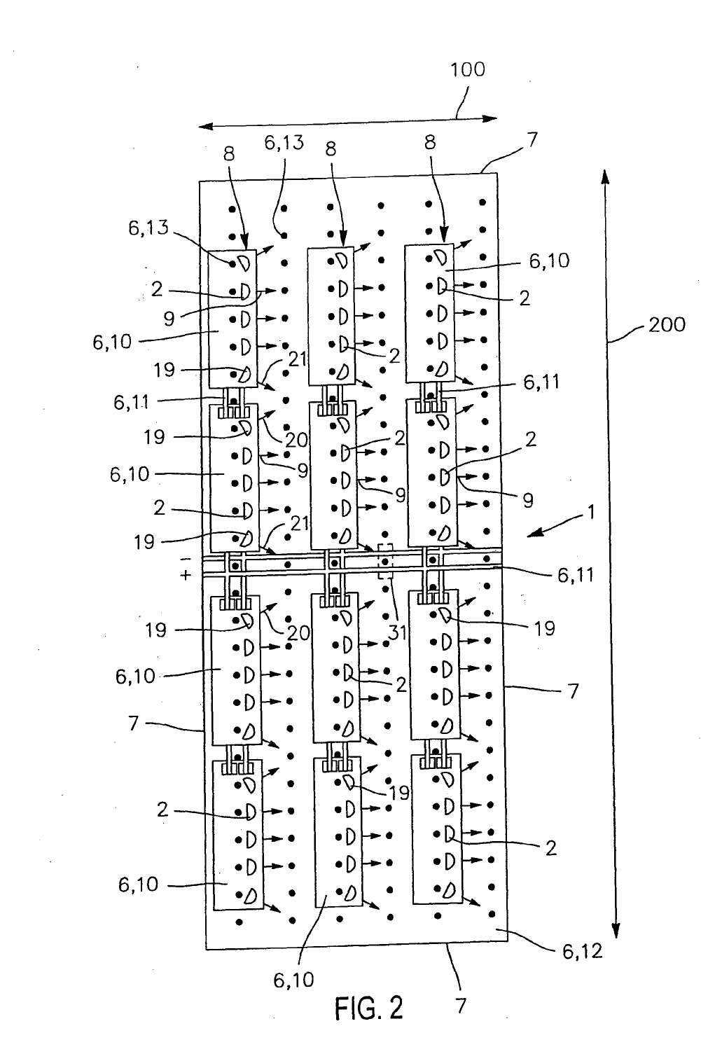

Thus, in the second embodiment of module according to the invention and with reference to FIG. 2, the assembly of the emission sources 2 of a given row 8 is carried by several printed circuits 10 electrically connected to each other parallel to the direction of alignment by wires 11 making it possible to supply the emission sources 2 of the given row. Thus in FIG. 2 four printed circuits 10 are shown per row 8, but a row could also comprise even more circuits 10. By multiplying the printed circuits 10 for a row 8, the width 200 of the module according to the invention is almost unlimited. This module 1 is particularly suitable for back-lighting large objects such as advertising posters, as it can be several metres in length and width.

In order to avoid the presence of badly lit zones between the printed circuits 10 of a single row 8, each printed circuit 10 of a given row 8 comprises at least one additional emission source 19 substantially aligned with the emission sources 2 carried by this circuit which emit light in the main direction of emission 9, each additional source 19 being arranged to emit light in a direction 20, 21 corresponding to the main direction 9 deflected towards another printed circuit of the row.

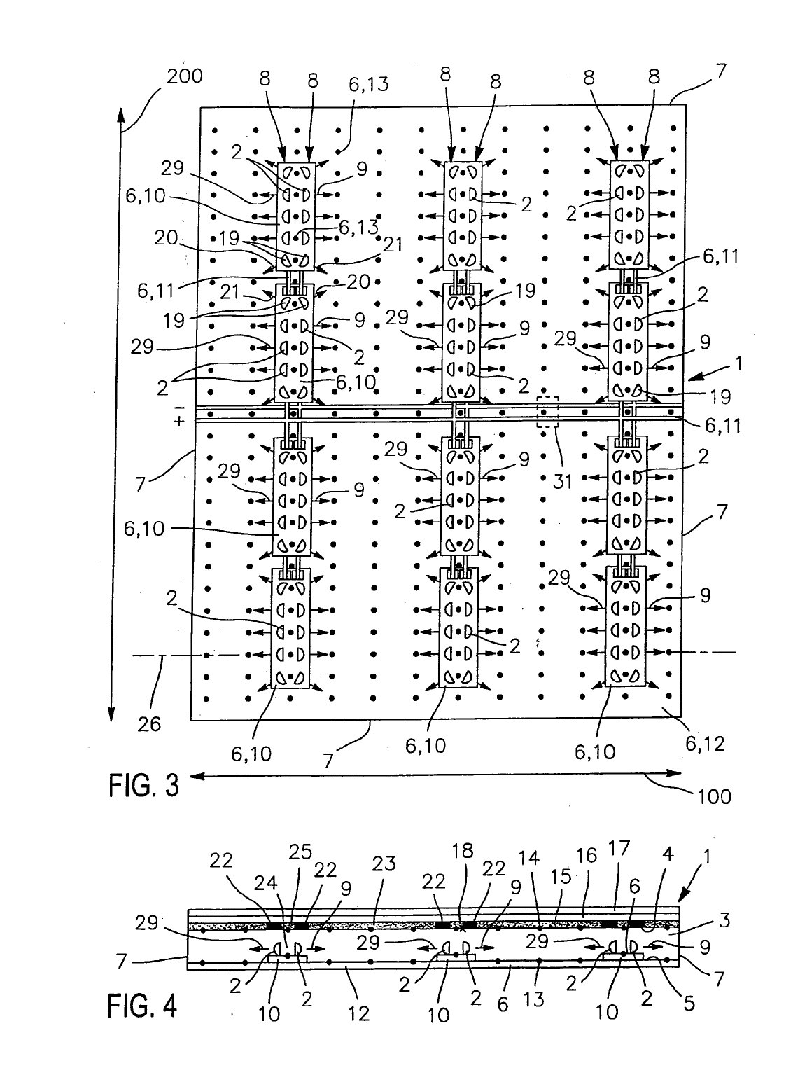

With reference to FIGS. 3 to 6, in the third and fourth embodiment of the module according to the invention described only with respect to their differences in relation to the second mode, each printed circuit 10 comprises:
a first line of emission sources 2 arranged to emit light in a first main direction of emission 9, and
a second line of emission sources 2 parallel with the first alignment and of which the emission sources are arranged to emit light in a second main direction of emission 29, the first direction of emission 9 being approximately opposite to the second direction of emission 29 when the module 1 is laid flat.

This makes it possible to increase the distance between the printed circuits 10 perpendicularly to the direction of alignment, and to reduce the costs of manufacture of the module 1.

With reference to FIGS. 3 and 4, for each printed circuit 10 of the third embodiment of the module according to the invention, the first and the second line of sources of this circuit are back-to-back in relation to their respective directions of emission 9, 29. In other words, for a given circuit, the first line of sources of this circuit emits in a first direction 9 substantially opposite to the direction starting from the first line towards the second line of this circuit, and the second line of sources of this circuit emits in a second direction 29 substantially opposite to the direction starting from the second line towards the first line of this circuit. Thus, for a given circuit, there is a poorly lit zone 24 between the first and the second line of sources of this circuit. The film 15 thus comprises moreover additional clear strips 25 (having a high transmission coefficient) between the first line and the second line of each circuit 10.

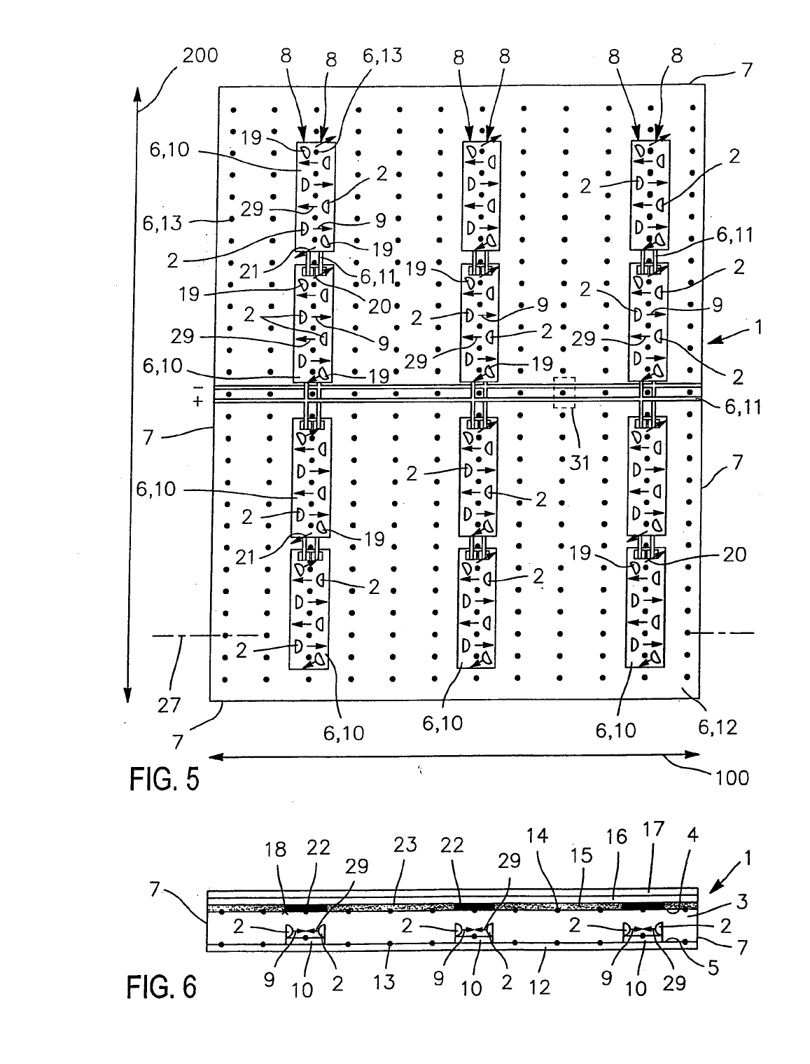

With reference to FIGS. 5 and 6, for each printed circuit 10 of the fourth embodiment of the module according to the invention, the first and the second line of sources of this circuit are face-to-face in relation to their respective directions of emission 9, 29. In other words, for a given circuit, the first line of sources of this circuit emits in a first direction 9 which points towards the second line of this circuit, and the second line of sources of this circuit emits in a second direction 29 which points towards the first line of this circuit. Thus, the fourth embodiment of the module according to the invention does not comprise the poorly lit zones 24 and the additional clear strips 25 of the third embodiment.

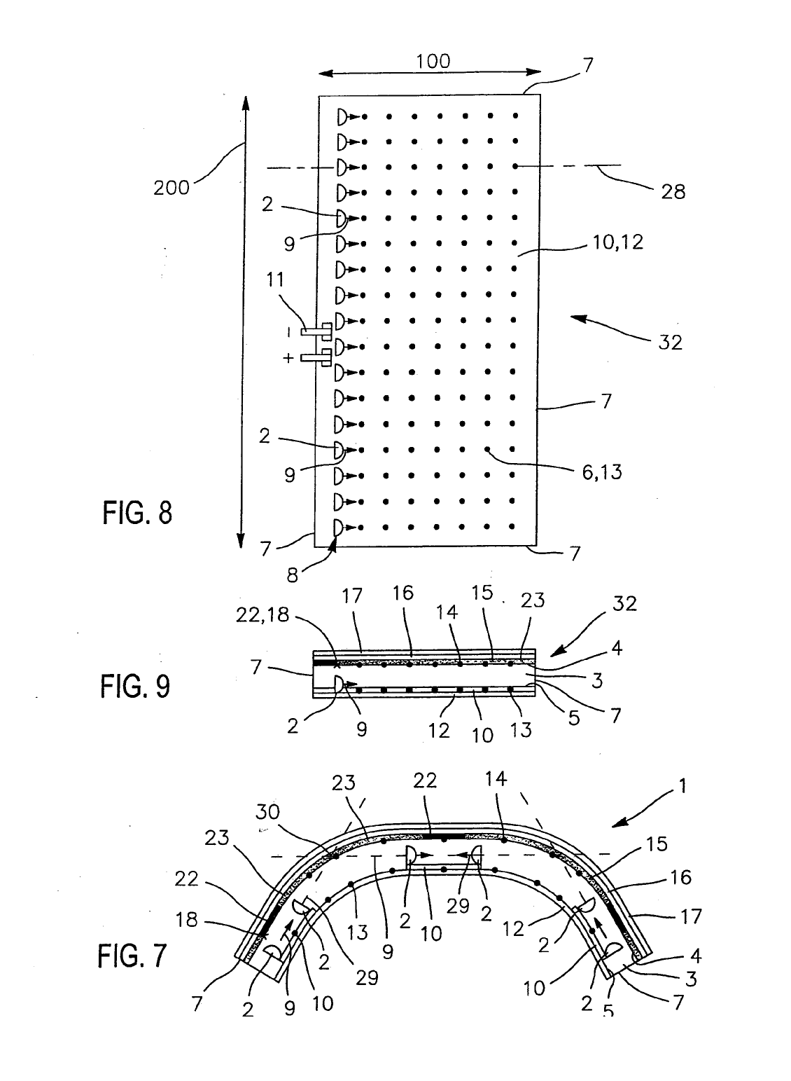

FIG. 7 illustrates in profile a variant of the fourth embodiment of the module according to the invention represented in FIG. 5. In this variant, the film 15 is arranged to compensate for an inhomogeneity of the light emerging from the transmission face 4 due to a curvature of the guide 3. The film 15 comprises local minima 30 of the transmission coefficient of the light at the level of each intersection between two directions of emission 9, 29 of two emission sources or two rows of emission sources.

In a variant (not shown) of the third and fourth embodiment of the module according to the invention, each first line of sources can be aligned with one of the second lines of sources. Thus, this variant of the module according to the invention comprises several rows 8 of emission sources, the emission sources of a given row emitting alternately in the first 9 and the second 29 directions of emission.

The particular features of each of the embodiments of the module according to the invention represented in FIGS. 10 to 16 will now be described. These embodiments will be described only in respect of their differences in relation to the third embodiment of FIGS. 3 and 4.

Each of the embodiments of FIGS. 10 to 16 comprises a guide 3 obtained by moulding. In fact, in order to produce the module 1, the insertion of the sources into the guide comprises a moulding of at least one part of the guide on a substrate on which the emission sources are arranged.

In the case of the embodiments illustrated in FIGS. 10 and 11, the substrate does not form part of the module, and the moulded part of the guide is removed from the substrate.

In the case of the embodiments illustrated in FIGS. 12 to 16, the substrate forms part of the module, and the moulded part of the guide is not removed from the substrate.

In the particular case of the sixth embodiment of module 1 illustrated in FIG. 10, a moulding face of the guide corresponding to the return face 5 is in contact with the substrate during moulding. The substrate comprises recessed structures distributed on its surface which is in contact with the moulded part 35 of the guide during the moulding so that the guide comprises protrusions distributed on the moulding face, having a shape of a portion of a sphere and serving as diffusion source 13. After having removed the guide 3 from the substrate, the moulded part of the guide is completed by adding:
on the side of the return face 5, a layer of air 34 which is in contact with the return face; this layer of air is situated between the return face 5 and the reflecting surface 12, and
on the side of the transmission face 4, a layer of air 34 which is in contact with the transmission face; this layer of air is situated between the transmission face 4 and the diffuser film 33.

In the particular case of the seventh embodiment of module 1 illustrated in FIG. 11, a moulding face of the guide corresponding to the return face 5 is in contact with the substrate during the moulding. After having removed the guide 3 from the substrate, the moulded part of the guide 35 is completed by adding:
on the side of the return face 5, a layer of air 34 which is in contact with the return face; this layer of air is situated between the return face 5 and the reflecting surface 12, and
on the side of the transmission face, a layer 36 which has a refractive index substantially equal to a refractive index of the moulded part 35 of the guide, which completes the moulded part of the guide, which forms part of the guide 3 and which comprises a distribution of recessed and protruding structures serving as diffusion source 14, and
on the side of the transmission face 4, a layer of air 34 which is in contact with the transmission face; this layer of air is situated between the layer 36 and the diffuser 33, i.e. between the transmission face 4 and the diffuser film 33.

In the particular case of the eighth embodiment of module 1 illustrated in FIG. 12, a moulding face of the guide corresponding to the transmission face 4 is in contact with the substrate during moulding. The substrate comprises the recessed and protruding structures distributed on its surface which is in contact with the moulded part 35 of the guide during moulding so that the guide comprises respectively protrusions and/or recesses distributed on the moulding face and serving as diffusion source 14. The moulded part of the guide 35 is completed by adding:
on the side of the return face 5, a layer of air 34 which is in contact with the return face; this layer of air is situated between the return face 5 and the reflecting surface 12.

The substrate comprises:
the diffuser 33, and
a layer 37:
   which is in contact with the transmission face of the guide,
   situated between the transmission face and the diffuser,
   which comprises the recessed and protruding structures distributed on the surface of the substrate, and
   which has a refractive index less than a refractive index of the moulded part 35 of the guide.

In the particular case of the ninth embodiment of module 1 illustrated in FIG. 13, a moulding face of the guide corresponding to the transmission face 4 is in contact with the substrate during moulding. The substrate comprises a layer 36 which is in contact with the moulded part 35 of the guide, which has a refractive index approximately equal to a refractive index of the moulded part of the guide, which completes the moulded part of the guide and which forms part of the guide 3. This layer 36 having an equal index comprises protruding structures serving as diffusion source 14 and distributed on a first surface opposite a second surface which is in contact with the moulded part of the guide. The first face of the layer 36 having an equal index is placed in contact with a layer of air 34; this layer of air is situated between the layer 36 and the diffuser 33, i.e. between the transmission face 4 and the diffuser 33.

The moulded part of the guide 35 is completed by adding:
on the side of the return face 5, a layer of air 34 which is in contact with the return face; this layer of air is situated between the return face 5 and the reflecting surface 12.

In the particular case of the tenth embodiment of module 1 illustrated in FIG. 14, a moulding face of the guide corresponding to the return face 5 is in contact with the substrate during the moulding. The substrate comprises a layer 36 which is in contact with the moulded part 35 of the guide, which has a refractive index approximately equal to a refractive index of the moulded part 35 of the guide, which completes the moulded part of the guide and which forms part of the guide 3. This layer 36 having an equal index comprises protruding structures serving as diffusion source 13 and distributed on a first surface opposite a second surface which is in contact with the moulded part of the guide. The first face of the layer 36 having an equal index is placed in contact with a layer of air 34; this layer of air is situated between the layer 36 and the reflecting layer 12, i.e. between the return face 5 and the reflecting layer 12.

The moulded part of the guide 35 is completed by adding:
on the side of the transmission face 4, a layer of air 34 which is in contact with the transmission face; this layer of air is situated between the transmission face 4 and the diffuser 33.

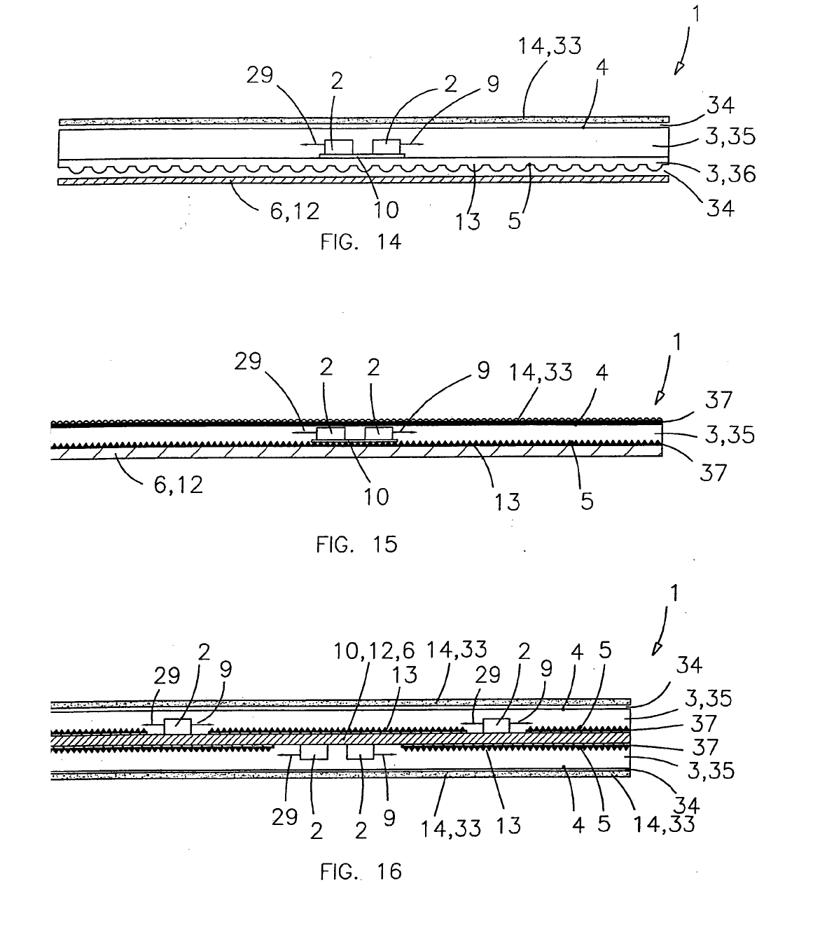

In the particular case of the eleventh embodiment of module 1 illustrated in FIG. 15, a moulding face of the guide corresponding to the return face 5 is in contact with the substrate during moulding. The substrate comprises recessed and protruding structures distributed on its surface which is in contact with the moulded part 35 of the guide during moulding so that the guide comprises respectively protrusions and/or recesses distributed on the moulding face and serving as diffusion source 13. The moulded part of the guide 35 is completed by adding on the side of the transmission face 4, a layer 37:
which is in contact with the transmission face of the guide,
situated between the transmission face and the diffuser 33, and
which has a refractive index less than a refractive index of the moulded part 35 of the guide.

The substrate comprises:
the reflective layer 12, and
a layer 37:
   which is in contact with the return face of the guide,
   situated between the return face 5 and the reflective layer 12,
   which comprises the recessed and protruding structures distributed on the surface of the substrate, and
   which has a refractive index less than a refractive index of the moulded part 35 of the guide.

In the particular case of the twelfth embodiment of module 1 illustrated in FIG. 16, a moulding face of the guide corresponding to the return face 5 is in contact with the substrate during moulding. The substrate comprises recessed and protruding structures distributed on its surface which is in contact with the moulded part 35 of the guide during moulding so that the guide comprises respectively protrusions and/or recesses distributed on the moulding face and serving as diffusion source 13. The moulded part of the guide 35 is completed by adding on the side of the transmission face 4, a layer of air 34:
which is in contact with the transmission face of the guide, and
situated between the transmission face and the diffuser 33.

The substrate comprises:
the printed circuit(s) 10 carrying the emission sources and serving as a reflective layer 12, and
a layer 37:
   which is in contact with the return face of the guide,
   situated between the return face 5 and the reflective layer 12,
   which comprises the recessed and protruding structures distributed on the surface of the substrate, and
   which has a refractive index less than a refractive index of the moulded part 35 of the guide.

The printed circuit(s) 10 carrying the emission sources serve as a reflective layer 12, and comprise a reflecting layer such as a white ink and a layer of UV gel having a lower index than that of the guide 3. The reflective layer 12 carries emission sources on its two opposite faces. This twelfth embodiment comprises two light guides 3 produced in turn as explained above on each of the two sides of the reflective layer 12.

The particular features of each of the embodiments of the module according to the invention illustrated in FIGS. 17 to 22 will now be described.

The thirteenth, fifteenth and sixteenth embodiments illustrated in FIGS. 17, 18, 21 and 22 will be described only as regards their differences with respect to the third embodiment illustrated in FIGS. 3 and 4.

The fourteenth embodiment illustrated in FIGS. 19 and 20 will only be described as regards its differences with respect to the fourth embodiment illustrated in FIGS. 5 and 6.

For each of the embodiments of the module according to the invention illustrated in FIGS. 17 to 22, the directions 9 and 29 are not necessarily opposite but are different. The projections of the directions 9 and 29 on the plane of the transmission face 4 are opposite.

Each of the embodiments of the module according to the invention illustrated in FIGS. 17 to 22 comprises a strip 38, a sectional view slice of which is shown in the figures with a cross-hatched lines. On one of the faces of the strip, an elongated recess 39 is formed along this strip. This recess can be a simple recess as illustrated in FIGS. 17, 18 and 21, or a recess provided with several protrusions as illustrated in FIGS. 19, 20 and 22. The strip 38 carries two lines of emission sources situated inside the elongated recess 39 and aligned along of the elongated recess, the recess being filled with material forming part of the light guide. Each line is arranged to emit light in a different direction 9, 29. Each emission source carried inside the elongated recess 39 is arranged to emit light in a direction of emission which is substantially parallel to a portion of the recess of the strip carrying this source. The strip 38 is situated on the side of the return face 5 of the guide, is in contact with the return face 5, and comprises a part of the reflective layer 12 arranged for returning towards the inside of the guide, light emitted by the emission sources and received by the return face. The reflective layer 12 is produced on the outside of the strip 38 (i.e. on the face not comprising the recess 39) by spraying a white spray or a white ink or a white epoxy resin onto the assembly of the return face of parts 40, 41 of the guide 3 or onto an intermediate layer (such as a layer 37 having an optical index less than that of the guide 3) situated on the side of the return face 5. The strip 38 is transparent to light, and the face of the strip carrying the emission sources, forming the recess 39 and in contact with the guide 3 is produced in a material having an index less than that of the guide 3 in order to increase the refraction. The return face 5 of the guide 3 is thus composed both by the first 40 and the second 41 part of the guide 3. In a variant of these embodiments, the reflective layer 12 is produced inside the strip 38.

At each end of the strip 38, the strip carries inside the recess 39, emission sources which light in the direction of the outside of the recess, substantially perpendicularly to the direction of emission 9, 29 of the two lines of sources. Each source carried inside the elongated recess 39 is preferably arranged to emit light in a direction of emission substantially parallel to a portion of the recess of the strip carrying this source.

Each of the embodiments of the module according to the invention illustrated in FIGS. 17 to 22 is preferably produced according to the following process:
the recessed side of the strip 38 (i.e. the face of the strip 38 on which the recess 39 is formed) is applied on a substantially flat first part 40 of the light guide,
the recess 39 is filled with the liquid or pasty material in order to form a second part 41 of the light guide in contact with the first part of the light guide.

The strip is applied on the side of the return face of the guide.

Before the filling, the first part 40 of the light guide is solid.

The strip 38 comprises a filling hole 43 through which the recess is filled with the liquid or pasty material. Once it is positioned on the main part 40 of the guide, the strip is filled with resin. The filling hole 43 makes it possible to pour the liquid or pasty resin into the strip. Each of the two ends of the strip 38 is closed with a stopper. The hole 43 is situated on one of these stoppers. Each stopper is equipped with a valve, for example a ball valve or a valve comprising an elastomer tube which deforms under the pressure of the liquid or pasty material during the filling of the recess 39. One of the stopper comprises a valve at the hole 43, this valve being arranged for avoiding that the liquid or pasty material goes out of the hole 43 when the injection of liquid or pasty material is unplugged, and the other stopper comprises another valve arranged for allowing the air to exit the recess 39 during the filling. An injection of the resin as a sheet makes it possible to avoid air zones. Furthermore, one of the stoppers comprises electrical fixed connectors, and serves as electrical connecxion housing for supplying electrical power to the emission sources carried by this strip.

The second part 41 of the light guide is solidified after the filling. After its solidification, the second part 41 is integral with the first part 40 of the guide, with no air space between these parts 40 and 41.

After the solidification of the second part 41 of the guide, the first part 40 and the second part 41 of the light guide 3 are integral along a seam 42.

Each of the embodiments of the module according to the invention illustrated in FIGS. 17 to 22 comprises, on the side of the transmission face 4, a layer 33 or 36 as described previously and serving as diffusion sources 14. This layer 33 is optional. The module 1 does not comprise this layer 33 in the case where the module 1 is intended to be bonded onto a diffuser panel or plate.

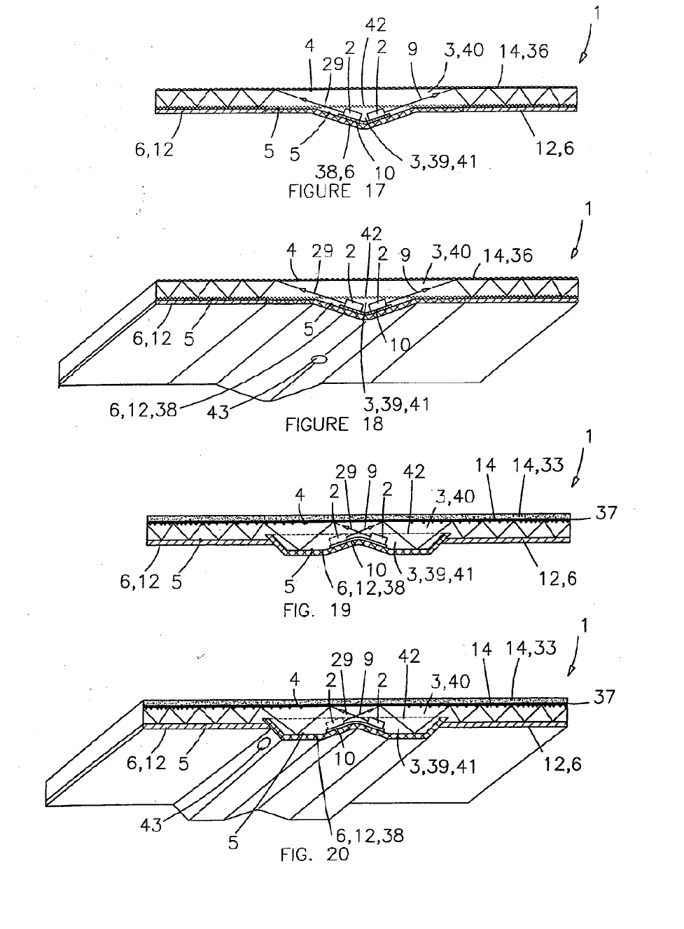

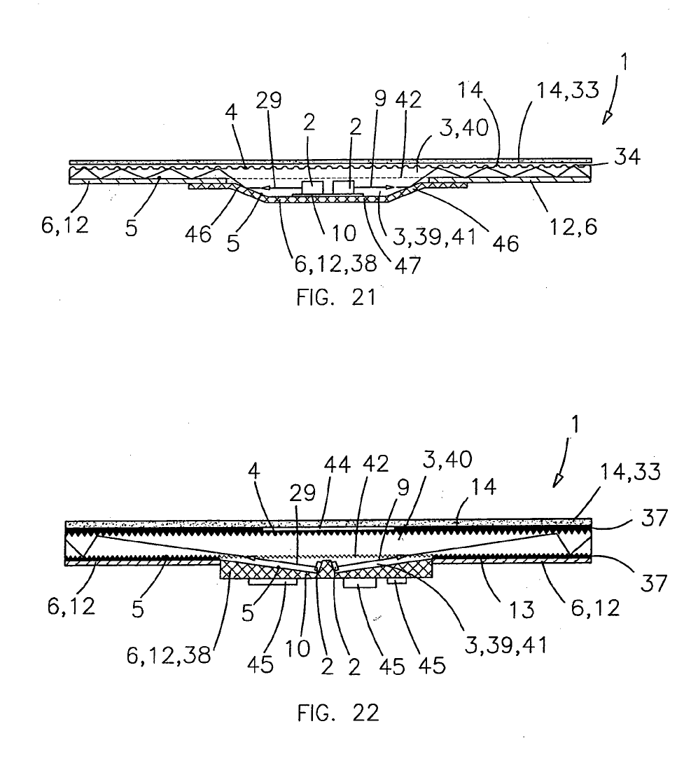

Moreover, as illustrated in FIGS. 17 to 22, each of these embodiments of the module according to the invention can comprise, on the side of the return face 5 or the transmission face 4:
a layer of air 34 which is in contact respectively with the return face or the transmission face of the guide, as illustrated on the side of the transmission face in FIG. 21, and/or
a layer 37 which has a refractive index less than a refractive index of the guide and which is in contact respectively with the return face or the transmission face of the guide, as illustrated on the side of the transmission face 4 in FIGS. 19, 20 and 22, and as illustrated on the side of the return face 5 in FIG. 22, and/or
recessed and/or protruding structures distributed on the transmission face 4, as illustrated on the side of the transmission face 4 in FIG. 21, and/or
recessed and/or protruding structures distributed on the return face 5, as illustrated on the side of the return face 5 in FIGS. 17 and 18.

In the particular case of the embodiment illustrated in FIG. 22, the electronic components and the constant current electronic control means 45 for controlling the emission sources are integrated in the strip 38, and the strip is supplied directly with 220V, this strip being such as an “extra-flat LED bulb”. Similarly, for all the other embodiments of the module 1, the electronic components and the electronic control 45 can be integrated on the face of the printed circuit 10 which is not in contact with the guide 3 (as illustrated in FIG. 22) or on the face of the printed circuit 10 which is in contact with the guide 3 and which carries the emission sources if the sources are power LEDs.

In the particular case of the embodiment illustrated in FIG. 21, the strip 38 comprises:
a flat surface 47 forming the bottom of the recess 39 and which is substantially parallel to the transmission face
two edges 46 which line the recess 39 along the strip 38, and which are oblique in relation to the transmission face 4 and the surface 47

and each line of sources 2 is arranged to emit light in a direction 9 or 29 which is directed towards one of the edges 46 and which is substantially parallel to the transmission face, the directions 9 and 29 being opposite.

Of course, FIGS. 17 to 22 illustrate a single strip 38, but the modules 1 partially illustrated in these figures preferably comprise several strips 38 parallel and regularly arranged on the side of the return face 5 of the module 1.

For each of the embodiments of the module according to the invention illustrated in FIGS. 17 to 22, the strip 38 can be produced with an extruded profile or an injected piece having reflective properties (white), optionally provided on the inside face (i.e. on the side of the recess) with a layer of a gel having an index less than that of the guide. The sources are placed inside this strip, then a resin is poured onto the sources, the profile serving to hold the printed circuit 10 and the sources and making it possible to contain the resin. This strip is bonded onto the main part of the guide 40.

In a variant, the recess 39 is firstly filled with the liquid or pasty material then the strip is applied against the main part of the guide 40. The recess 39 can be filled via the hole 43 or directly by pouring the liquid or pasty material on the face of the strip 38 on which the recess 39 is formed. Thus, the strip can be applied or bonded onto the main part 40 of the guide during the solidification of the part 41 and in this case the excess liquid or pasty material is removed when the strip 38 is flattened against the part 40. Moreover, the strip can be applied or bonded on the main part 40 of the guide after the solidification; in this case the strip 38 is preferably filled via the hole 43 after having applied the strip 38 onto a support such as a glass plate. If the strip is applied onto the main part 40 of the guide after solidification of part 41, a contact gel is placed between the parts 40 and 41 in order to avoid any air interstices between the parts 40 and 41, and the strip 38 is held on the module 1 using an external pressure or an adhesive.

For each of the embodiments of the module according to the invention illustrated in FIGS. 17 to 22, the main part 40 of the guide can be manufactured by extrusion or moulding according to a manufacturing process by moulding identical to that described with reference to FIGS. 10 to 16, and it is possible to deposit on this main part 40 on the side of the return 5 and/or transmission face 4 recessed and/or protruding structures 13, 14 by stamping or by UV gel, layers of air 34, layers 37 having a lower index, etc. as described with reference to FIGS. 10 to 16.

Furthermore, for each of the embodiments of the module according to the invention illustrated in FIGS. 17 to 22, the recess 39 allows to use emission sources that are more voluminous and more powerful.

In a variant of the embodiments of the module according to the invention illustrated in FIGS. 17 to 22, the strip 38 is metallic, and comprises for example aluminium. Furthermore, the strip 38 comprises cooling means arranged to dissipate heat emitted by the emission sources carried by this strip, like for example ribs increasing the cooling surface of the strip or a fan or a cooling circuit.

Generally, for the embodiments of the module according to the invention described previously, the function of each layer of air 34 and each layer 37 having an index less than that of the guide is to create a difference in the optical index between the guide 3 and the outside of the guide at the level of the return 5 or of transmission face 4, in order to reflect at least partially towards the inside of the guide 3, light originating from the guide and reaching the level of the return 5 or transmission face 4. Thus the light is “trapped” inside the guide 3, which allows the guide to guide and transport the light emitted by the sources. Of course, the reflection of light towards the guide 3 must not be total at the level of the transmission face 4, in order for the light to reach the object to be lit by the module 1. Each layer of air 34 can be replaced by a layer 37 having an index less than that of the guide.

For the embodiments illustrated in FIGS. 10 to 22:
the moulded 35 or main part 40 of the guide can be produced:
   by casting, the moulded 35 or main part 40 of the guide comprising for example acrylic resin cross-linked by UV or epoxy resin, or silicone rubbers having 2 components cross-linked by heating from 110° C. to 120° C.
   by hot pressing, the moulded 35 or main part 40 of the guide comprising a thermoplastic silicone film placed on the emission sources and the substrate; the temperature of implementation is low, from 100° C. to 120° C.
   By extrusion, the moulded 35 or main part 40 of the guide comprising PMMA (polymethyl methacrylate), COC (cyclic olefin copolymer), polycarbonate (PC), or polyester
the layers 37 are typically made of UV gel or acrylic resin or epoxy resin having a low index approximately equal to 1.3

It is noted that, for all the embodiments which have just been described with reference to FIGS. 1 to 7 and 10 to 22, a limited number of rows 8 is shown in the figures illustrating these embodiments. A module 1 can be envisaged having a very long length by multiplying the number of parallel rows 8 connected by wires 11. The module 1 can typically comprise tens, hundreds or more parallel rows 8, it can thus have a length 100 of several metres or more. Being flexible, it is preferably rolled on its length around an axis parallel to the rows 8, in order to be stored in the form of a roll. Modules of different lengths can be cut from this roll, along a cutting line parallel to the rows 8, depending on the desired application.

Along its length 100, the roll comprises means of periodic access to the wires 11, such as for example holes 31 formed in the layer 12 and situated at the level of the wires 11 periodically along the length 100 of the roll. Of course, these means of access are spatially periodic, i.e. they are situated with a spatial periodicity on the module 1. The holes 31 are typically accessible via tabs formed in the layer 12 and capable of being detached from the module according to the invention. These means of periodic access make it possible to provide an electrical supply to the emission sources of any module cut from the roll and having a length greater than the periodicity of the holes 31.

In a variant free of wires 11 connecting the strips to each other, the roll comprises, along its length 100, periodic means of access and electrical connection, such as for example electrical connection wires exiting at the level of each printed circuit strip which carries emission sources. As these means of connection are accessible from the outside of the module, this arrangement offers greater flexibility for controlling the emission sources. Of course, these means of access are spatially periodic, i.e. that they are situated with a spatial periodicity on the module 1.

The lighting module according to the invention can also be small in size, for example for a back-lighting application for a label in a supermarket, a small street sign or a standby light.

The diffuser film 33 is preferably:
a PET (polyethylene terephthalate) film with a coating of microbeads, as illustrated in FIGS. 10 to 14, 16 and 19 to 22, or
a special pattern formed on a UV gel, comprising for example a layer of hemispheres, as illustrated in FIG. 15.

For the embodiments illustrated in FIGS. 11 to 13 and 22, the module 1 comprises a layer 44 serving to mask the light close to the emission sources. This layer consists of printed material. In the case of FIGS. 12 and 13, the substrate comprises this layer 44.

Generally, the reflective layer 12 can be a white film (for example made of polyester) or a film with a metallic coating.

With reference to FIGS. 8 and 9, a fifth embodiment of module 32 according to the invention will now be described, only with respect to its differences in relation to the first embodiment illustrated in FIG. 1. The module 32 comprises only a single row 8 of emission sources 2, the length of the module 32 being typically from 15 to 30 centimetres. All the emission sources 2 of the module 32 are carried by a single printed circuit 10. The reflective layer 12 is produced between the printed circuit 10 and the guide 3, typically by a surface treatment of the circuit 10 pressed against the return face 5.

Of course, the invention is not limited to the examples which have just been described and numerous adjustments can be made to these examples without exceeding the scope of the invention. In particular, in the embodiments described previously, the upper layer 17 can consist of a light diffusion layer, so that two diffusion layers 14, 17 frame the layer of lenses 16. Thus, the module according to the invention is not used as a back-lighting module but is used as a source of ambient light, emitting a diffuse light for example in a room of a house or in a vehicle.

Finally, one of the embodiments of the module according to the invention can comprise moreover emission sources or diodes called “top view” which can:
be carried by the printed circuit(s) 10,
emit in the direction of the transmission face 4,
be situated between two rows 8 of “side view” sources which emit substantially parallel to the reflection face 5.

These “top view” emission sources can thus contribute to eliminating shadow zones between rows 8 of “side view” sources.

The emission sources can be produced directly on the printed circuit(s) 10.

For each of the embodiments, a mask 44 can be produced directly on the light guide 3, on the side of the transmission face 4 to mask the light close to these sources of emission, by producing:
a first thin UV gel print on the transmission face 4, then
a dark colour printing over the thin UV gel, then
a coating over the colour printing, with beads and diffuser resin or a diffuser pattern (hemispheres).

In this document, each strip 38 along which an elongated recess 39 is formed can be assembled with at least one other strip along which an elongated recess is formed. For example, by assembling two strips 38 perpendicularly to an other strip 38 and at the ends of this other strip, a treble strip is obtained, this treble strip having a capital I shape and comprising three recesses. Preferably, there is no discontinuity between the recesses of the different assembled strips.

In this document, every “printed circuit” mentioned can be more generally replaced with a substrate arranged for carrying the emission sources and comprising means for electrically connecting the sources.

Finally, the module 1 can be used for:
creating an ambient lighting for example in a room or in the form of a dome light of a motor vehicle.
lighting the contents of shelving or furniture, the module 1 being flat, having a small space requirement and giving off a small amount of heat,
lighting a room or objects as a substitute for a group of neon tubes,
back-lighting various objects, for example a small label on a supermarket shelf or a large advertising poster in a street.
back-lighting a commercial sign, an advertising sign or a street sign, or
back-lighting an LCD screen, in particular a large-dimension LCD screen.

1. Lighting module (1, 32) comprising:
a plurality of light emission sources (2, 19),
a light guide (3) comprising a transmission face (4) arranged to transmit light emitted by the emission sources (2, 19) towards an object to be lit and a return face (5) opposite the transmission face (4), and
means (6, 12, 13) for returning towards the inside of the guide (3), light emitted by the emission sources (2, 19) and received by the return face (5),
characterized in that the emission sources (2, 19) are situated on the inside of the light guide (3) between the transmission face (4) and the return face (5), and are arranged to emit light in a direction of emission (9, 20, 21, 29) substantially parallel to the return face (5).

2. Module according to claim 1, characterized in that the emission sources are situated in the guide without intermediate space between the guide and the emission sources, in particular without an air space.

3. Module according to claim 1, characterized in that the guide comprises an initially liquid or pasty material which is solidified after insertion of the emission sources in the guide.

4. Module according to claim 1, characterized in that the emission sources are carried by at least one printed circuit.

5. Module according to claim 1, characterized in that the guide comprises lateral edges connecting the transmission face and the return face, at least one row of emission sources (2, 19) being situated inside the light guide (3) between the transmission face (4) and the return face (5) outside the lateral edges of the guide.

6. Module according to claim 1, characterized in that the return means (6) comprise light diffusion sources (13) situated on the side of the return face (5) with respect to the guide (3), and arranged to collect the light emitted by the emission sources (2, 19) and received by the return face (5) then to re-diffuse the collected light towards the guide (3).

7. Module according to claim 6, characterized in that the diffusion sources situated on the side of the return face (5) comprise recessed and/or protruding structures distributed on the return face.

8. Module according to claim 1, characterized in that it comprises moreover light diffusion sources (14) situated on the side of the transmission face (4) with respect to the guide (3), and arranged to collect the light emitted by the emission sources (2, 19) and received by the transmission face (4) then to re-diffuse the collected light towards the object to be lit.

9. Module according to claim 8, characterized in that the diffusion sources situated on the side of the transmission face (4) comprise recessed and/or protruding structures distributed on the transmission face.

10. Module according to claim 1, characterized in that it comprises moreover on the side of the return face or the transmission face of the guide:
a layer of air which is in contact respectively with the return face or the transmission face of the guide, or
a layer which has a refractive index less than a refractive index of the guide and which is in contact respectively with the return face or the transmission face of the guide.

11. Module according to claim 1, characterized in that it comprises a strip along which an elongated recess is formed, the strip carrying at least one line of emission sources situated inside the elongated recess and aligned along the elongated recess, the recess being filled with material forming part of the light guide.

12. Module according to claim 11, characterized in that the strip carries two lines of emission sources inside the elongated recess, each line being arranged to emit light in a different direction.

13. Module according to claim 11, characterized in that each source carried inside the elongated recess is arranged to emit light in a direction of emission (9, 20, 21, 29) substantially parallel to a portion of the recess of the strip carrying this source.

14. Module according to claim 11, characterized in that the strip is situated on the side of the return face of the guide, and comprises means for returning towards the inside of the guide light emitted by the emission sources and received by the return face.

15. Process for manufacturing a lighting module, characterized in that:
emission sources are inserted into a light guide comprising a material which is initially liquid or pasty, the light guide (3) comprising a transmission face (4) arranged for transmitting light emitted by the emission sources (2, 19) towards an object to be lit and a return face (5) opposite the transmission face (4), the emission sources (2, 19) being inserted so that they are situated inside the light guide (3) between the transmission face (4) and the return face (5) the material of the guide is solidified after insertion of the sources into the guide.

16. Process according to claim 15, characterized in that the insertion comprises a coating of the emission sources with the liquid or pasty material.

17. Process according to claim 15, characterized in that the sources are inserted so that the sources are situated in the guide without intermediate space between the guide and the emission sources, in particular without an air space.

18. Process according to claim 15, characterized in that the emission sources (2, 19) are inserted between the transmission face (4) and the return face (5) so that the sources are arranged to emit light in a direction of emission (9, 20, 21, 29) substantially parallel to the return face (5).

19. Process according to claim 15, characterized in that during the insertion of the sources into the guide, the sources are carried by at least one printed circuit.

20. Process according to claim 15, characterized in that the guide comprises lateral edges connecting the transmission face and the return face, and in that at least one row of sources is inserted outside the lateral edges of the guide.

21. Process according to claim 15, characterized in that the insertion comprises a moulding of at least one part of the guide on a substrate on which the emission sources are arranged.

22. Process according to claim 21, characterized in that a moulding face of the guide from the transmission or return faces is in contact with the substrate during moulding, the substrate comprising recessed and/or protruding structures distributed on its surface which is in contact with the moulded part of the guide during moulding so that the guide comprises respectively protrusions and/or recesses distributed on the moulding face.

23. Process according to claim 21, characterized in that the moulded part of the guide is completed by adding on the side of the return face or the transmission face of the guide:
a layer of air which is in contact respectively with the return face or the transmission face of the guide, or
a layer which has a refractive index less than a refractive index of the guide and which is in contact respectively with the return face or the transmission face of the guide
and/or a layer which has a refractive index approximately equal to a refractive index of the moulded part of the guide, which completes the moulded part of the guide, which forms part of the guide and which comprises a distribution of recessed and/or protruding structures.

24. Process according to claim 21, characterized in that the substrate does not form part of the module, and in that the moulded part of the guide is removed from the substrate.

25. Process according to claim 21, characterized in that the substrate forms part of the module, the moulded part of the guide not being removed from the substrate.

26. Process according to claim 25, characterized in that the substrate comprises means (6, 12, 13) for returning towards the inside of the guide (3) the light emitted by the emission sources (2, 19) and received by the return face (5).

27. Process according to claim 25, characterized in that the substrate comprises means (33) for diffusing towards the outside of the guide (3), light emitted by the emission sources (2, 19) and received by the transmission face (4).

28. Process according to claim 25, characterized in that the substrate comprises a layer which is in contact with the transmission or return face of the guide and which has a refractive index less than a refractive index of the guide.

29. Process according to claim 25, characterized in that the substrate comprises a layer which is in contact with the moulded part of the guide, which has a refractive index approximately equal to a refractive index of the moulded part of the guide, which completes the moulded part of the guide and which forms part of the guide.

30. Process according to claim 29, characterized in that this equal index layer comprises recessed and/or protruding structures distributed on a first surface opposite a second surface which is in contact with the moulded part of the guide.

31. Process according to claim 30, characterized in that the first face of the equal index layer is placed in contact with a layer of air or with a layer which has a refractive index less than a refractive index of the guide.

32. Process according to claim 15, characterized in that the insertion of the sources into the guide comprises the following steps:
providing a strip along which an elongated recess is formed, the strip carrying at least one line of emission sources situated inside the elongated recess and aligned along the elongated recess,
application of the recessed side of the strip onto a first part of the light guide,
filling the recess with the liquid or pasty material in order to form a second part of the light guide in contact with the first part of the light guide.

33. Process according to claim 32, characterized in that before filling, the first part of the light guide is solid, the second part of the light guide being solidified after filling.

34. Process according to claim 32, characterized in that the strip comprises a filling hole through which the recess is filled with the liquid or pasty material.

35. Process according to claim 32, characterized in that the strip carries two lines of emission sources inside the elongated recess, each line being arranged to emit light in a different direction.

36. Process according to claim 32, characterized in that each source carried inside the elongated recess is arranged to emit light in a direction of emission (9, 20, 21, 29) substantially parallel to a portion of the recess of the strip carrying this source.

37. Process according to claim 32, characterized in that the strip is applied on the side of the return face of the guide, and comprises means for returning towards the inside of the guide, light emitted by the emission sources and received by the return face.

38. Module obtained by the process according to claim 15.

39. Strip for the manufacture of a module by the process according to claim 32, characterized in that an elongated recess is formed along this strip, the strip carrying at least one line of emission sources inside the elongated recess and aligned along the elongated recess.

40. Strip according to claim 40, characterized in that the strip comprises a filling hole for filling the recess with liquid or pasty material when the strip is applied onto a first part of a light guide on the recessed side of the strip.

41. Strip according to claim 39, characterized in that it carries two lines of emission sources inside the elongated recess, each line being arranged to emit light in a different direction.

42. Strip according to claim 39, characterized in that each source carried inside the elongated recess is arranged to emit light in a direction of emission substantially parallel to a portion of the recess of the strip carrying this source.

43. Strip according to claim 39, characterized in that the strip comprises means of reflecting the light emitted by the emission sources.
